(19) United States
(12) Patent Application Publication
(10) Pub. No.: US 2009/0195098 A1
(43) Pub. Date: Aug. 6, 2009

(54) Starter for cranking internal combustion engine

(75) Inventors: Shinji Usami, Okazaki-city (JP); Kazuhiro Andoh, Okazaki-city (JP); Shinji Andoh, Nagoya-city (JP)

Correspondence Address: OLIFF & BERRIDGE, PLC, P.O. BOX 320850, ALEXANDRIA, VA, 22320-4850, US

(73) Assignee: Denso Corporation, Kariya-city (JP)

(21) Appl. No.: 12/289,898

(22) Filed: Nov. 6, 2008

(30) Foreign Application Priority Data
Feb. 1, 2008 (JP) 2008-22571

(51) Int. Cl. H02K 7/108

(52) U.S. Cl. 310/78

(57) ABSTRACT

A starter for cranking an internal combustion engine includes an electric motor, an output shaft, a pinion gear coupled to the output shaft. The starter motor further includes one-way clutch for transmitting the rotational torque of the electric motor to the output shaft while interrupting transmission of the rotational torque from the pinion gear driven by the engine to the electric motor. A clutch-inner of the one-way clutch is integrally formed with the output shaft. When the output shaft is driven by the engine via the pinion gear, a swinging rotation may be caused due to a small inclination of the output shaft relative to a real center axis of the starter. To suppress the swinging rotation, a washer is connected to a front end of the one-way clutch, and the washer is adapted to contact a rear end of the sliding bearing supporting the output shaft when the output shaft is rotated by the engine.

### CROSS-REFERENCE TO RELATED APPLICATION

This application is based upon and claims benefit of priority of Japanese Patent Application No. 2008-22571 filed on Feb. 1, 2008, the content of which is incorporated herein by reference.

### BACKGROUND OF THE INVENTION

1. Field of the Invention

The present invention relates to a starter for cranking an internal combustion engine.

2. Description of Related Art

An example of a starter for cranking an internal combustion engine is shown in JP-A-9-88780. The starter includes an output shaft, which is rotatably supported by a sliding bearing disposed in a center case and another sliding bearing disposed in a housing, a pinion gear coupled to the output shaft via a helical spline, and a one-way clutch for transmitting a rotational torque of an electric motor to the output shaft. A clutch-inner of the one-way clutch is formed integrally with the output shaft at its rear end.

In the starter described in JP-A-9-88780, there is a tendency that the output shaft rotates in a state declined relative to a center axis of the starter (this rotation is referred to as swinging rotation) when the clutch-inner is rotated by the engine at a high speed after the engine is cranked up. The swinging rotation may occur if there is a small rotational imbalance in the output shaft including the clutch-inner. The swinging rotation may generate vibration and noises in the starter. The swinging rotation of the clutch-inner is transferred to a clutch-outer, causing difficulty in no-load rotation of the one-way clutch. In order to prevent these problems in the conventional starter, it has been required to reduce a clearance in the sliding bearing and/or improve a rotational balance of the output shaft including the clutch-inner. However, those measures for suppressing the swinging rotation require a considerable cost in manufacturing the starter.

### SUMMARY OF THE INVENTION

The present invention has been made in view of the above-mentioned problem, and an object of the present invention is to provide an improved starter, in which the swinging rotation of the output shaft is suppressed by providing a simple structure.

The starter for cranking an internal combustion engine includes an electric motor generating a rotational torque, an output shaft to which the rotational torque of the electric motor is transmitted via a speed reduction device and a one-way clutch, and a pinion gear coupled to the output shaft via a helical spline. The one-way clutch transmits the rotational torque of the electric motor to the output shaft while interrupting transmission of the rotational torque from the output shaft to the electric motor. The one-way clutch is composed of a clutch-outer that is rotated by the rotational torque of the electric motor, a clutch-inner formed integrally with the output shaft, rollers for transmitting the rotational torque from the clutch-outer to the clutch-inner, and a center case covering an outside of the one-way clutch and the speed reduction device.

Upon starting the electric motor, the pinion gear is shifted to a frontward of the starter to be engaged with a ring gear of the engine. The engine is cranked up by the rotational torque of the electric motor. After the engine is cranked up, the pinion gear is rotated by the engine, and the rotational speed of the clutch-inner becomes higher than that of the clutch-outer (overrunning state). Under the overrunning state, the output shaft may be rotated while it is a little inclined relative to a real center line of the starter (referred to as a swinging rotation). The swinging rotation generates noises in the one-way clutch and prevents a smooth no-load rotation of the one-way clutch.

To avoid the above situation, a washer is connected to the front surface of the one-way clutch. The washer is positioned to contact a rear end of a sliding bearing supporting the output shaft when the output shaft is shifted frontward by a return reaction of the pinion gear. Since the washer rotates in contact with the rear end of the sliding bearing in the overrunning state, the inclination of the output shaft is suppressed, and the swinging rotation of the output shaft is suppressed.

It is possible to add a flange having a diameter larger than that of the sliding bearing to the rear end of the sliding bearing. In this manner, an area of the sliding bearing contacting the washer is enlarged to further improve suppression of the swinging rotation. A projected portion for contacting the washer may be formed on a rear surface of the center case. Further, it is also possible to make both of the rear end of the sliding bearing and the projected portion contact the washer to further improve suppression of the swinging rotation.

According to the present invention, the swinging rotation of the output shaft is effectively suppressed by adding a simple structure. Other objects and features of the present invention will become more readily apparent from a better understanding of the preferred embodiments described below with reference to the following drawings.

### BRIEF DESCRIPTION OF THE DRAWINGS

FIG. 1 is a cross-sectional view showing a relevant part of a starter as a first embodiment of the present invention;

FIG. 2 is a cross-sectional view showing a one-way clutch used in the starter shown in FIG. 1;

FIG. 3 is a cross-sectional view showing a one-way clutch as a second embodiment of the present invention;

FIG. 4 is a cross-sectional view showing a one-way clutch as a third embodiment of the present invention; and

FIG. 5 is a cross-sectional view showing a one-way clutch as a fourth embodiment of the present invention.

### DETAILED DESCRIPTION OF THE PREFERRED EMBODIMENTS

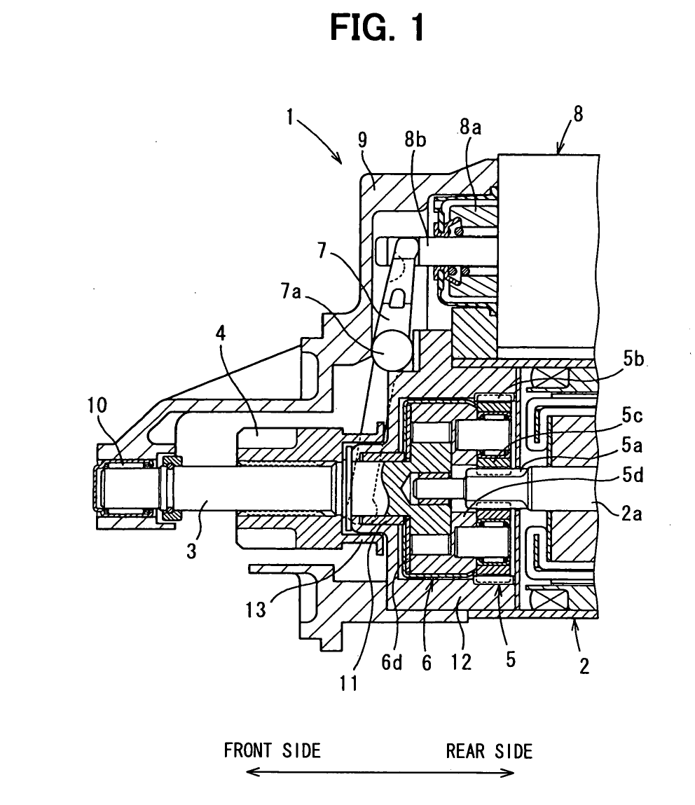

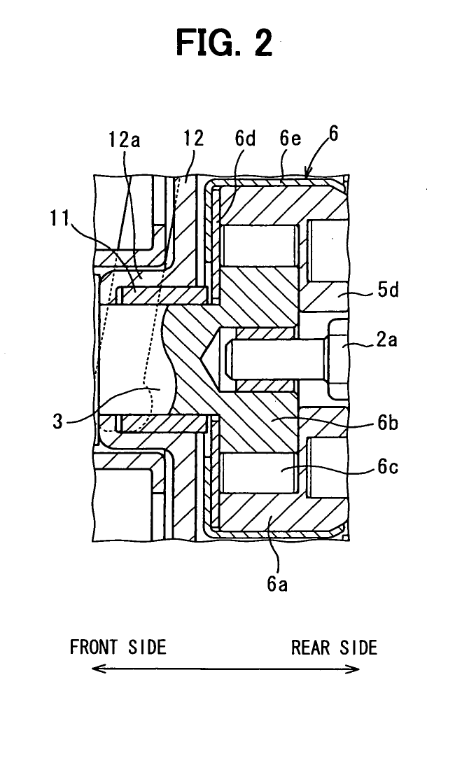

A first embodiment of the present invention will be described with reference to FIGS. 1-2. First, referring to FIG. 1, a structure of a starter for cranking an internal combustion engine will be described. The starter 1 includes an electric motor 2 generating a rotational torque, an output shaft 3 disposed in line with an armature shaft 2a of the electric motor 2, a pinion gear 4 coupled to the output shaft 3 via a helical spline, a speed reduction device 5 for reducing a rotational speed of the electric motor 2, and an one-way clutch 6 for transmitting a rotational torque of the electric motor 2 to the output shaft 3.

The starter 1 further includes an electromagnetic switch 8 for opening or closing main contacts of the electric motor 2 and for pushing the pinion gear 4 toward a ring gear of the engine (not shown) via a shift lever 7, and a housing 9 accommodating the electric motor 2, the electromagnetic switch 8 and other components therein.

The electric motor 2 is a known direct current motor, which is driven by supplying direct current from an on-board battery upon closing the main contacts. The output shaft 3 is rotatably supported by a sliding bearing 10 held at a front end of the housing 9 and another sliding bearing 11 held in a center case 12. The front side and the rear side of the starter 1 are marked in all drawings attached hereto. The center case 12 is firmly held in the housing 9 not to rotate and not to shift in the axial direction. The center case 12 covers outsides of the speed reduction device 5 and the one-way clutch 6. The sliding bearing 11 is press-fitted (forcibly inserted) in an inner bore of a bearing portion 12a of the center case 12 (refer to FIG. 2). A rear end of the sliding bearing 11 extends toward the rear side beyond a rear surface of the center case 12.

The pinion gear 4 is shifted toward the front side by a shift lever 7 driven by the electromagnetic switch 8 and is engaged with the ring gear of the engine. The rotational torque of the electric motor 2 is transmitted to the ring gear via the pinion gear 4. The speed reduction device 5 is a planetary gear type speed reduction device and is composed of a sun gear 5a formed on a front portion of the armature shaft 2a, an internal gear 5b held in the center case 12, planetary gears 5c engaging with both of the sun gear 5a and the internal gear 5b, and a carrier 5d for rotatably supporting the planetary gears 5c and for outputting an orbital rotation of the planetary gears 5c to the one-way clutch 6.

As shown in FIG. 2, the one-way clutch 6 is composed of an clutch-outer 6a forming a cam chamber therein, a clutch inner 6b coaxially disposed inside the clutch-outer 6a, rollers 6c disposed in the cam chamber between the clutch-outer 6a and the clutch-inner 6b, springs pushing the rollers 6c (not shown) toward a narrower space in the cam chamber, a washer 6d disposed in contact with front ends of the clutch-outer 6a and the clutch-inner 6b, and a clutch cover 6e for fixing the washer 6d to the clutch-outer 6a by staking. The clutch outer 6a is formed integrally with the carrier 5d of the speed reduction device 5, and the clutch-inner 6b is formed integrally with the output shaft 3 at its rear end.

The clutch-outer 6a is rotated by the orbital rotation of the planetary gears 5c around the sun gear 5a. The rollers in the cam chamber move toward the narrower space in the cam chamber to thereby transmit rotation of the clutch-outer 6a to the clutch-inner 6b. On the other hand, when the pinion gear 4 is rotated by the engine and the rotational speed of the clutch-inner 6b exceeds the rotational speed of the clutch-outer 6a (this state is referred to as an overrunning state), transmission of the torque between the clutch-inner 6b and the clutch-outer 6a is interrupted because the rollers move to a wider space in the cam chamber.

The washer 12 functions as a retainer for retaining the rollers 6c and the springs in the cam chamber. It also functions to keep the clutch-inner 6b inside the clutch-outer 6a not to move out in the axial direction. An inner diameter of the washer 12 is made smaller than an outer diameter of the sliding bearing 11. The inner portion of the washer 12 is positioned between the rear end of the sliding bearing 11 and the front surface of the clutch-inner 6b. An amount of the rear end of the sliding bearing 11 extending from the rear surface of the center case 12 is made larger than a thickness of the clutch cover 6e. In other words, the washer 12 is positioned to be able to contact the rear end of the sliding bearing 11, when the output shaft 3 shifts to the front side together with the clutch-inner 6b.

The electromagnetic switch 8 is a known type, which is composed of a solenoid coil having a plunger 8a. Upon energizing the solenoid coil, the plunger 8a is attracted to the rear side to close the main contacts of the electric motor and to drive the shift lever 7 for shifting the pinion gear 4 toward the ring gear. The lever 7 is supported by a fulcrum 7a held in the housing 9 at a middle portion thereof. One end of the lever 7 is connected to a plunger rod 8b connected to the plunger 8a, and the other end of the lever is engaged with a barrel portion 13 formed on the pinion gear 4. Upon energizing the electromagnetic switch 8, the pinion gear 4 is shifted frontward by the lever 7.

Operation of the starter 1 will be briefly explained. Upon supplying electric current to the solenoid coil of the electromagnetic switch 8, the pinion gear 4 is shifted to the front side by the lever 7 and abuts an end surface of the ring gear. Then, upon closing the main contacts, the electric motor 2 rotates and generates a rotational torque. The rotation of the armature shaft 2a is transmitted to the output shaft 3 via the one-way clutch 6 after the rotational speed of the armature shaft 2a is reduced by the speed reduction device 5. The pinion gear 4 abutting the ring gear is rotated by rotation of the output shaft 3, and thereby the ring gear 4 engages with the ring gear. Thus, the engine is cranked up by the rotational torque of the electric motor 2.

After the engine is cranked up, the output shaft 3 becomes the overrunning state where the pinion gear 4 is rotated by the ring gear of the engine. The output shaft 3 is shifted toward the front side by a return reaction of the pinion gear 4, and the washer 12 abuts the rear end of the sliding bearing 11. As a result, a front surface of the clutch-inner 6b abuts the rear end of the sliding bearing 11 via the washer 12. The clutch-inner 6b rotates along the rear end of the sliding bearing 11. Accordingly, the inclination of the output shaft 3 relative to the center axis of the starter 1 is suppressed, and the swinging rotation of the output shaft 3 is suppressed. Thus, the one-way clutch 6 smoothly interrupts transmission of torque from the output shaft 3 to the electric motor 2 under the overrunning state.

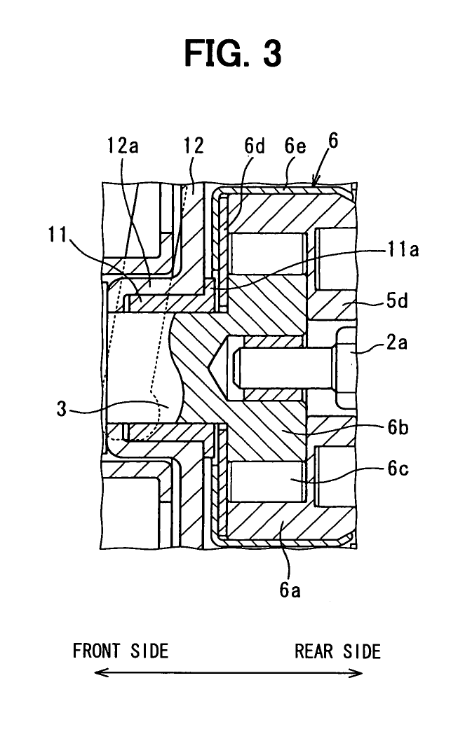

A second embodiment of the present invention is shown in FIG. 3. In this embodiment, a flange 11a having a diameter larger than the outer diameter of the sliding bearing 11 is formed at the rear end of the sliding bearing 11. Other structures and functions are the same as those of the first embodiment. Since the area of the sliding bearing 11 contacting the washer 12 is increased in this embodiment, the inclination of the output shaft 3 or the swinging rotation thereof is surely suppressed.

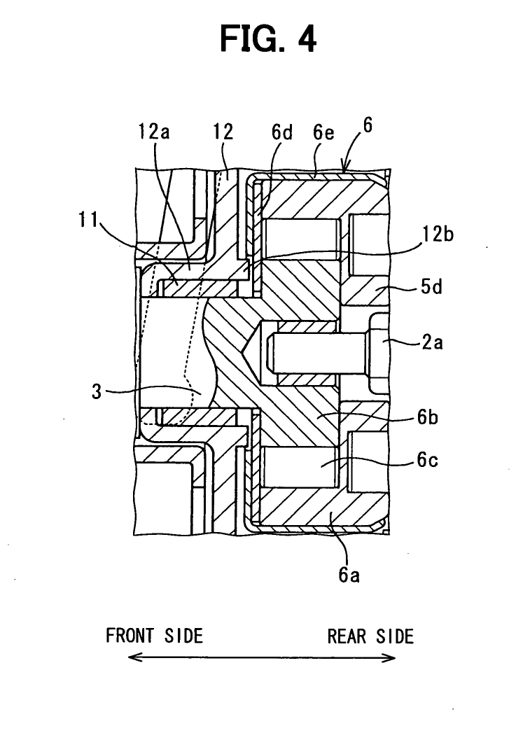

A third embodiment of the present invention is shown in FIG. 4. In this embodiment, though the rear end of the sliding bearing 11 is made flush with the rear surface of the center case 12, a projected portion 12b projected from the rear surface of the center case 12 is formed. A height of the projected portion 12b is made larger than the thickness of the clutch over 6e, so that the washer 6d contacts the projected portion 12b when the output shaft 3 is shifted to the front side. Other structures and functions are the same as those of the first embodiment. Since the clutch inner 6b rotates along the rear end surface of the projected portion 12b via the washer 6d in the overrunning state, the inclination or the swinging rotation of the output shaft 3 is suppressed.

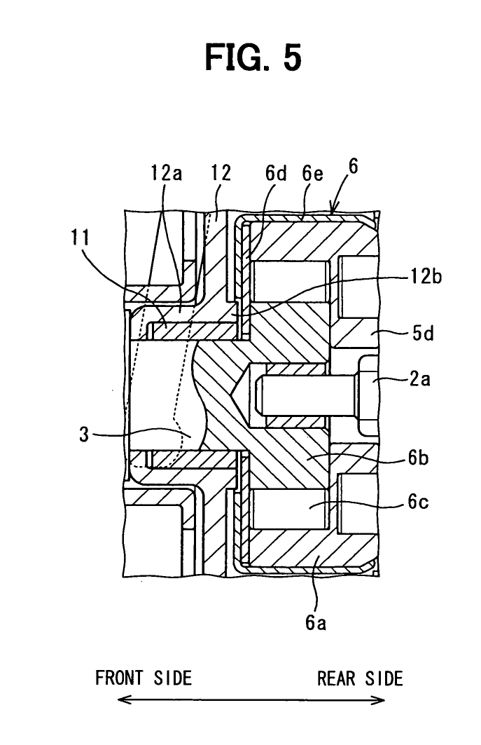

A fourth embodiment of the present invention is shown in FIG. 5. In this embodiment, a projected portion 12b is formed on the rear surface of the center case 12, and a rear end of the projected portion 12b is made flush with the rear end of the sliding bearing 11. An amount of the projection of the projected portion 12b is made larger than a thickness of the clutch cover 6e, so that the washer 6d contacts both of the rear end of the sliding bearing 11 and the projected portion 12b when the output shaft 3 is shifted to the front side. Other structures and functions are the same as those of the first embodiment. Since both of the rear end of the sliding bearing 11 and the projected portion 12b contact the washer 6d, the contacting area is enlarged compared with the first embodiment. Accordingly, the inclination or the swinging rotation of the output shaft 3 in the overrunning state is surely suppressed.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A starter for cranking an internal combustion engine, comprising:
an electric motor generating a rotational torque;
an output shaft disposed in line with an armature shaft of the electric motor;
a pinion gear coupled to the output shaft via a helical spline;
a one-way clutch for transmitting the rotational torque of the electric motor to the output shaft while interrupting transmission of the rotational torque from the output shaft to the electric motor, the one-way clutch having: a clutch-outer to which the rotational torque of the electric motor is transmitted; a clutch-inner formed at a rear end of the output shaft by enlarging an outer diameter of the output shaft, the clutch-inner being disposed inside the clutch-outer to be rotatable relative to the clutch-outer; rollers for coupling or de-coupling rotational torque transmission between the clutch-outer and the clutch-inner; a washer for preventing the clutch-inner from being separated from the clutch-outer; and a clutch cover for fixing the washer to the clutch-outer; and
a center case rotatably supporting the output shaft via a sliding bearing, wherein:
a rear end of the sliding bearing extends beyond a rear surface of the center case that faces the one-way clutch; and
an inner diameter of the washer is made smaller than an outer diameter of the sliding bearing, and an inside portion of the washer is extended between the rear end of the sliding bearing and the clutch-inner, so that a front surface of the washer contacts the rear end of the sliding bearing when the output shaft is shifted to the front side of the starter.

2. The starter for cranking an internal combustion engine as in claim 1, wherein:
a flange having an outer diameter larger than that of the sliding bearing is formed at the rear end of the sliding bearing; and
the washer is disposed to contact a rear surface of the flange when the output shaft is shifted to the front side of the starter.

3. A starter for cranking an internal combustion engine, comprising:
an electric motor generating a rotational torque;
an output shaft disposed in line with an armature shaft of the electric motor;
a pinion gear coupled to the output shaft via a helical spline;
a one-way clutch for transmitting the rotational torque of the electric motor to the output shaft while interrupting transmission of the rotational torque from the output shaft to the electric motor, the one-way clutch having: a clutch-outer to which the rotational torque of the electric motor is transmitted; a clutch-inner formed at a rear end of the output shaft by enlarging an outer diameter of the output shaft, the clutch-inner being disposed inside the clutch-outer to be rotatable relative to the clutch-outer; rollers for coupling or de-coupling rotational torque transmission between the clutch-outer and the clutch-inner; a washer-for preventing the clutch-inner from being separated from the clutch-outer; and a clutch cover for fixing the washer to the clutch-outer; and
a center case rotatably supporting the output shaft via a sliding bearing, wherein:
the center case includes a projected portion projected from a rear surface of the center case; and
the washer is disposed to contact the projected portion when the output shaft is shifted to the front side of the starter.

4. The starter for cranking an internal combustion engine as in claim 3, wherein:
a rear end of the projected portion is made flush with the rear end of the sliding bearing; and
an inner diameter of the washer is made smaller than an outer diameter of the sliding bearing, and an inside portion of the washer is extended between the rear end of the sliding bearing and the clutch-inner, so that a front surface of the washer contacts the rear end of the sliding bearing and the projected portion when the output shaft is shifted to the front side of the starter.
